(19) United States
(12) Patent Application Publication
(10) Pub. No.: US 2018/0095966 A1
(43) Pub. Date: Apr. 5, 2018

(54) PRESENTING RANKED SEARCH RESULTS BASED ON ACCESSIBILITY SCORES

(71) Applicant: Microsoft Technology Licensing, LLC, Redmond, WA (US)

(72) Inventors: Adam Fourney, Redmond, WA (US); Ryen White, Woodinville, WA (US); Meredith Morris, Bellevue, WA (US); Shane Williams, Seattle, WA (US)

(73) Assignee: Microsoft Technology Licensing, LLC, Redmond, WA (US)

(21) Appl. No.: 15/285,222

(22) Filed: Oct. 4, 2016

(51) Int. Cl. G06F 17/30

(52) U.S. Cl. CPC G06F 17/3053; G06F 17/30864; G06F 17/3097; G06F 17/30554

(57) ABSTRACT

An example system for presenting search results includes a computer memory and a processor. The processor is to receive a set of search results in response to a query. The processor is to extract a feature and text from each of the search results. The processor is to also calculate an accessibility score for each of the search results based on the extracted feature and the text. The processor is to further rank the set of search results based on the accessibility score. The processor is to also further present the ranked search results based on an accessibility score of a user.

### BACKGROUND

Search engines retrieve search results including a number of web pages in response to queries from users. The search results are typically ranked according to relevance to the query. In some examples, other factors such as recency, reputation, among other factors may be used to rank search results.

### SUMMARY

The following presents a simplified summary of the innovation in order to provide a basic understanding of some aspects described herein. This summary is not an extensive overview of the disclosed subject matter. It is intended to neither identify key elements of the disclosed subject matter nor delineate the scope of the disclosed subject matter. Its sole purpose is to present some concepts of the disclosed subject matter in a simplified form as a prelude to the more detailed description that is presented later.

One implementation provides for a system for presenting search results. The system includes a computer memory and a processor to receive a set of search results in response to a query. The processor can extract a feature and text from each of the search results. The processor can calculate an accessibility score for each of the search results based on the extracted feature and the text. The processor can rank the set of search results based on the accessibility score. The processor can then present the ranked search results.

Another implementation provides a method for presenting search results. The method includes receiving a set of search results in response to a query. The method additionally includes extracting a feature and text from each of the search results. The method further includes calculating an accessibility score for each of the search results based on the extracted feature and the text. The method further includes ranking the set of search results based on the accessibility score. The method also includes presenting the ranked search results.

Another implementation provides for one or more computer-readable memory storage devices for storing computer readable instructions that, when executed by one or more processing devices, instruct the presentation of search results. The computer-readable instructions may include code to receive a set of search results in response to a query. The computer-readable instructions may also include code to extract a feature and text from each of the search results. The computer-readable instructions may also include code to calculate a accessibility score for each of the search results based on the extracted feature and the text. The computer-readable instructions may include code to rank the set of search results based on the accessibility score. The computer-readable instructions may include code to present the ranked search results.

The following description and the annexed drawings set forth in detail certain illustrative aspects of the disclosed subject matter. These aspects are indicative, however, of a few of the various ways in which the principles of the innovation may be employed and the disclosed subject matter is intended to include all such aspects and their equivalents. Other advantages and novel features of the disclosed subject matter will become apparent from the following detailed description of the innovation when considered in conjunction with the drawings.

### BRIEF DESCRIPTION OF THE DRAWINGS

FIG. 1 is a block diagram of an example system for presenting search results based on accessibility scores;

FIG. 2 is a process flow diagram of an example method for presenting search results based on accessibility scores;

FIG. 3 is a process flow diagram of an example method for calculating a accessibility score;

FIG. 4 is an example method for extracting features from search results;

FIG. 5 is an example method for modifying a browser to present search results with accessibility features based on an accessibility indicator of a user;

FIG. 6 is another example method for modifying a browser to present search results with accessibility features based on an accessibility indicator of a user;

FIG. 7 is a block diagram of an example operating environment configured for implementing various aspects of the techniques described herein; and

FIG. 8 is a block diagram showing example computer-readable storage media that can store instructions for presenting search results based on accessibility scores.

### DETAILED DESCRIPTION

As discussed above, search engines currently may take into account a relevancy, recency, and reputation when ranking search results in response to a query. However, such ranking may not provide very useful results for some individuals. For example, it is estimated that between 10% and 20% of people in the U.S. have dyslexia. People with dyslexia may face a variety of challenges related to reading, writing, and spelling. Moreover, each individual with dyslexia may face a different set of challenges related to reading, writing, spelling, or any combination thereof. Therefore, individuals with dyslexia and other reading disorders may experience difficulties using typical search engines.

Embodiments of the present techniques described herein provide a system, method, and computer-readable storage medium with instructions for presenting search results based on accessibility scores. In some examples, a processor may receive a set of search results in response to a query. For example, the query may be received via voice input. The processor can extract a feature and text from each of the search results. As used herein, an extracted feature may include a page structure, multimedia, a page integrity feature, or a visual clarity feature, among other possible features of a search result. As used herein, a text refers to the written content of a search result. The processor may then calculate an accessibility score for each of the search results. For example, the accessibility score can be based at least on a reading level of the extracted text. In some examples, the reading level may be based on an inclusion list of specific vocabulary words. The processor may then rank the set of search results based on the accessibility score and extracted feature. The processor may then modify a web browser to present the ranked search results in place of the set of search results. In some examples, an improved N-best list may be included in the search results. As used herein, an N-best list refers to a list of N results that are ranked higher than other results or above a threshold value. In some examples, the search results may be presented with a variety of improvements for improved accessibility. Advantageously, the present techniques may be used to provide individuals with search results that are more easily understood and browsed. Moreover, the present techniques may enable search engines to be used by some individuals that may not have been able to use search engines at all previously. The present techniques thus improve the usability of search engines generally and provide a set of search results that may be easily understood and an enhanced browser to easily browse through the improved search results.

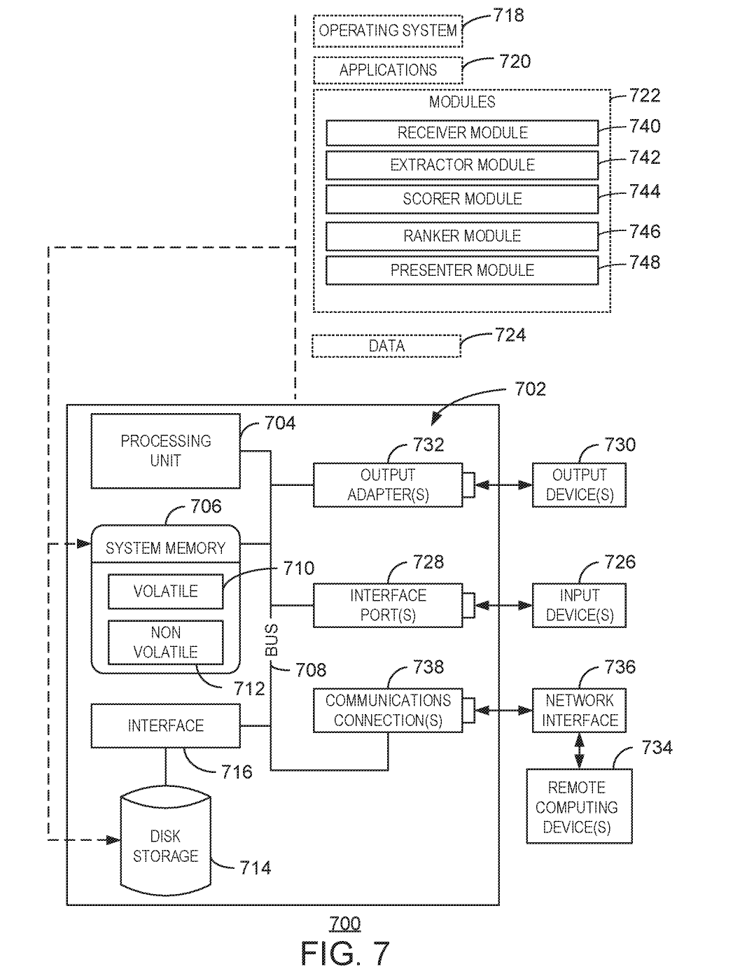

As a preliminary matter, some of the figures describe concepts in the context of one or more structural components, variously referred to as functionality, modules, features, elements, or the like. The various components shown in the figures can be implemented in any manner, such as software, hardware, firmware, or combinations thereof. In some cases, various components shown in the figures may reflect the use of corresponding components in an actual implementation. In other cases, any single component illustrated in the figures may be implemented by a number of actual components. The depiction of any two or more separate components in the figures may reflect different functions performed by a single actual component. FIG. 7, discussed below, provides details regarding one system that may be used to implement the functions shown in the figures.

Other figures describe the concepts in flowchart form. In this form, certain operations are described as constituting distinct blocks performed in a certain order. Such implementations are exemplary and non-limiting. Certain blocks described herein can be grouped together and performed in a single operation, certain blocks can be broken apart into multiple component blocks, and certain blocks can be performed in an order that differs from that which is illustrated herein, including a parallel manner of performing the blocks. The blocks shown in the flowcharts can be implemented by software, hardware, firmware, manual processing, or the like. As used herein, hardware may include computer systems, discrete logic components, such as application specific integrated circuits (ASICs), or the like.

As to terminology, the phrase “configured to” encompasses any way that any kind of functionality can be constructed to perform an identified operation. The functionality can be configured to perform an operation using, for instance, software, hardware, firmware, or the like. The term, “logic” encompasses any functionality for performing a task. For instance, each operation illustrated in the flowcharts corresponds to logic for performing that operation. An operation can be performed using, software, hardware, firmware, or the like. The terms, “component,” “system,” and the like may refer to computer-related entities, hardware, and software in execution, firmware, or combination thereof. A component may be a process running on a processor, an object, an executable, a program, a function, a subroutine, a computer, or a combination of software and hardware. The term, “processor,” may refer to a hardware component, such as a processing unit of a computer system.

Furthermore, the disclosed subject matter may be implemented as a method, apparatus, or article of manufacture using standard programming and engineering techniques to produce software, firmware, hardware, or any combination thereof to control a computing device to implement the disclosed subject matter. The term “article of manufacture,” as used herein is intended to encompass a computer program accessible from any computer-readable storage device or media. Computer-readable storage media include magnetic storage devices, e.g., hard disk, floppy disk, magnetic strips, optical disk, compact disk (CD), digital versatile disk (DVD), smart cards, flash memory devices, among others. Moreover, computer-readable storage media does not include communication media such as transmission media for wireless signals. In contrast, computer-readable media, i.e., not storage media, may include communication media such as transmission media for wireless signals.

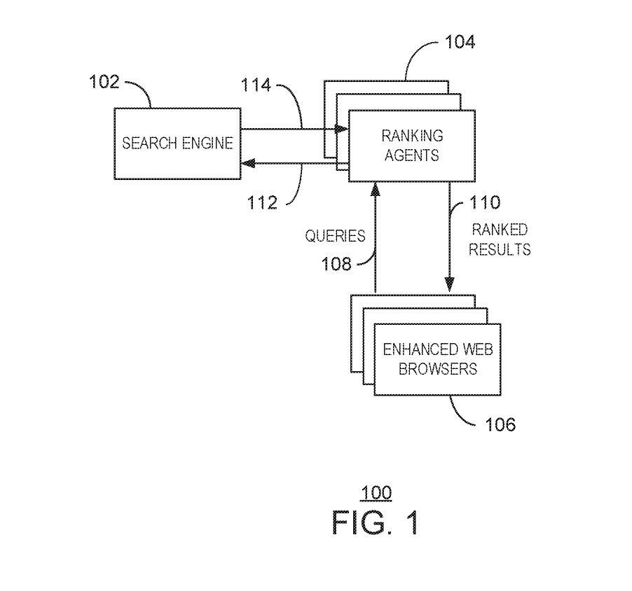

FIG. 1 is a block diagram of an example system for presenting search results based on accessibility scores. The system 100 includes a search engine 102, a ranking agent 104, and enhanced web browsers 106. The enhanced web browsers 106 may send queries 108 to ranking agents 104 and receive ranked results 110 from the ranking agents. For example, the ranking agents 104 may be implemented as browser plugins, as web-accessible search engines powered by search engine 102, or as a module in search engine 102. In some examples, the search engine 102 may provide an application programming interface (API) for requesting and receiving search results from the search engine 102.

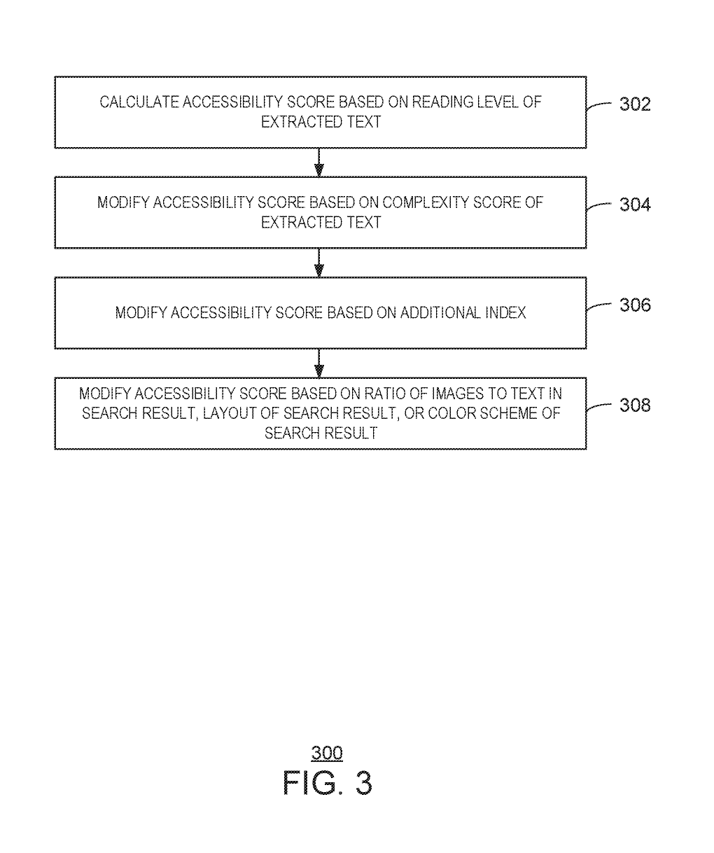

As shown in FIG. 1, ranking agents 104 may be used to receive queries 108 from a number of enhanced web browsers 106 and provide ranked results 110 in response. For example, the ranking agents 104 may forward 112 the queries to the search engine 102 and receive a set of query results 114. The ranking agents 104 may then extract features and text from each of a subset of the search results. For example, a predetermined number of top search results may be chosen for extracting features and text. In some examples, the features may include a page structure, multimedia, a page integrity feature, or a visual clarity feature, as discussed in greater detail below. The ranking agents 104 may then calculate an accessibility score for each of the search results based on the extracted features and text. For example, the accessibility score may be based at least on a reading level of the extracted text. In some examples, the accessibility score is based on a complexity score of the text, wherein the complexity score is calculated based on a mean number of characters per word, a mean number of words per sentence, a number of characters without spaces, a total number of words, a total number of sentences, a mean number of syllables per word, or any combination thereof. In some examples, the accessibility score is based on an additional index. For example, the additional index may be a Flesch Reading Ease score, a Flesh-Kincaid Grade Level, a Coleman Liau Index, a Gunning-Fog Index, a Simple Measure of Gobbledygook (SMOG), an automated readability index, a Dale-Chall formula, a Fry readability formula, or any combination thereof. For example, the reading score may be calculated using the method described in greater detail in FIG. 3 below. After calculating the accessibility score, each ranking agent 104 may then rank a set of search results based on the accessibility score. For example, different weights may be given to the text and the extracted features based on individual preferences.

Examples of the system 100 can take several different forms depending on the location of the search engine 102, the location of the ranking agents 104, etc. In some examples, multiple automated ranking agents 104 may operate in parallel to provide service to multiple enhanced web browsers 106.

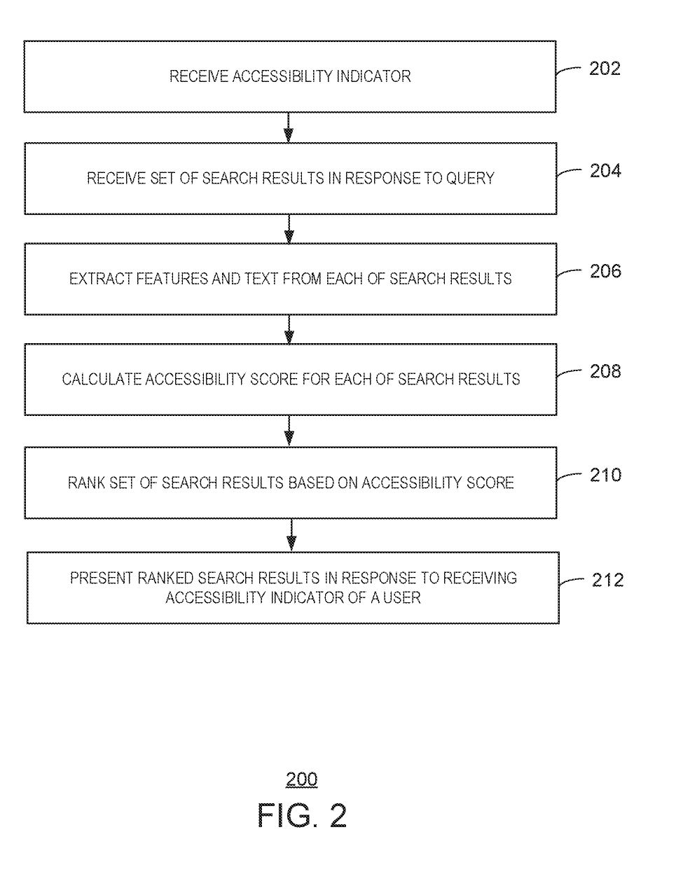

FIG. 2 is a process flow diagram of an example method for presenting search results based on accessibility scores. One or more components of hardware or software of the operating environment 700, may be configured to perform the method 200. For example, the method may be implemented via the processor 704. In some examples, various aspects of the method may be performed in a cloud computing system. The method 200 may begin at block 202.

At block 202, the processor receives an accessibility indicator of a user. In some examples, the accessibility indicator may indicate that a user has a particular condition. For example, the accessibility indicator may indicate that the user has dyslexia. In some examples, the accessibility indicator may include one or more preferences for accessibility. For example, the one or more preferences may be used to weight particular factors in calculating accessibility scores as discussed below. Thus, users with particular forms of dyslexia may indicate particular difficulties or accessibility features to be included in the search results using the accessibility indicator.

At block 204, the processor receives a set of search results in response to a query. For example, the search results may be received from a search engine that provides sorted resulted based on relevance. In some examples, the query may have been received via voice input, converted into text, and sent to the search engine.

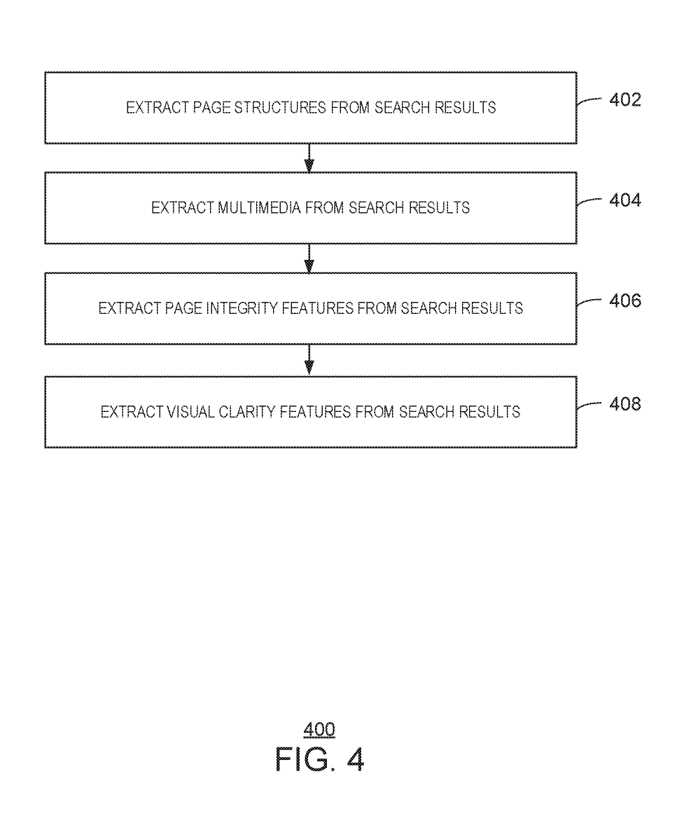

At block 206, the processor extracts features and text from each of the search results. For example, the feature may be a page structure, multimedia, a page integrity feature, or a visual clarity feature, among other possible features. These extracted features are discussed in greater length with respect to FIG. 4 below.

At block 208, the processor calculates an accessibility score for each of the search results based on the extracted features and the text. For example, the processor may assign coefficients for each extracted feature that is to be used in the accessibility score. Each of the scores for the extracted features may then be multiplied by the associated coefficient and then all the scores may be added together to generate a final accessibility score. In some examples, the weight or coefficient given to the extracted feature in the accessibility score may be adjustable. For example, the weight given to the extracted features may be based upon individual preferences or configurations. In some examples, one or more individual preferences may be received in the accessibility indicator. For example, if an accessibility score is to be based on an average sentence length and total number of images, and average sentence length is C times as important, then an example equation for calculating a accessibility score for the extracted features may be based on the ratio C:1:

Readability_Score=C*Avg_Sentence_length+1*Total_Images Eq. 1

The accessibility score for the extracted features may then be combined with the normal ranking features. In some examples, the normal ranking features may be combined with the extracted features using another weighted calculation. For example, if the regular ranking features are to be given a 90% weight and the extracted features a 10% weight, then the equation may be:

Final_Ranking_Score=0.9(regular_ranking_features_score)+0.1(C* Avg_Sentence_length+1*Total_Images) Eq. 2

In some examples, any suitable weights may be used. Accordingly, pages that are easier to read and thus more accessible may be ranked higher up in the ranking. In some examples, the accessibility score can be based at least on a reading level of the extracted text. In some examples, the accessibility score may be based on a complexity score of the text. For example, the complexity score may be calculated as discussed in greater detail with respect to FIG. 3 below. In some examples, the accessibility score may be based on an additional index, such as a Flesch Reading Ease score, a Flesh-Kincaid Grade Level, a Coleman Liau Index, a Gunning-Fog Index, a SMOG, an automated readability index, a Dale-Chall formula, a Fry readability formula, or any combination thereof. These example additional indices are also discussed in greater detail with respect to FIG. 3 below. In some examples, the accessibility can also be based on a ratio of images to text in each search result, a layout of each search result, or a color scheme of each search result.

At block 210, the processor ranks the set of search results based on the accessibility score. For example, the set of search results may be ranked with search results having higher accessibility scores being ranked higher and search results with lower accessibility scores being ranked lower.

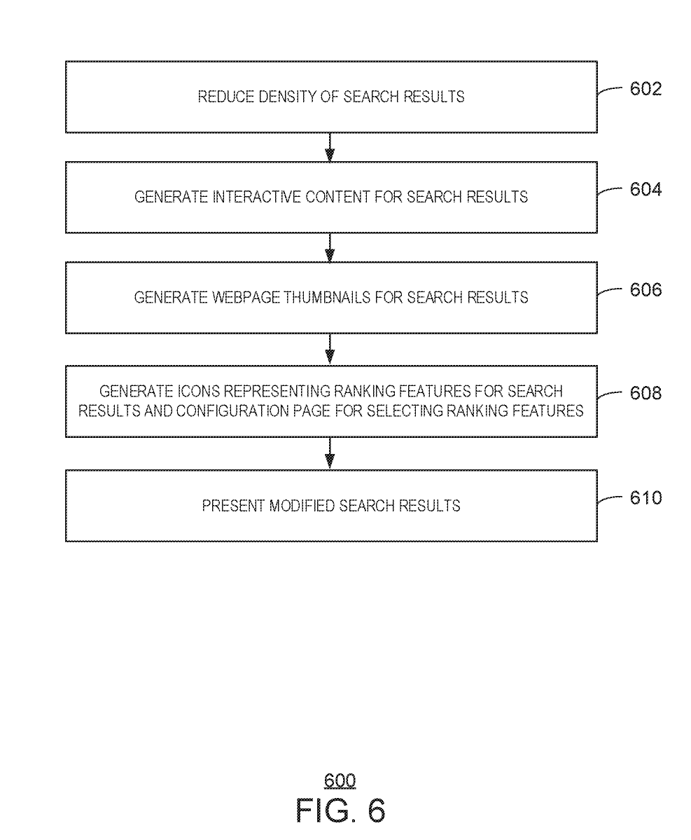

At block 212, the processor modifies a web browser to present the ranked search results in place of the set of search results in response to receiving the accessibility indicator. In some examples, the processor may present the ranked search results with one or more accessibility features for making the ranked search results easier to understand. For example, the processor may present the one or more accessibility features based on one or more preferences included in the accessibility indicator. In some examples, the processor may present the search results with a reduced density. For example, the processor may remove snippets of information or advertisements that may cause too much clutter. In some examples, the processor may present the search results with interactive content. For example, the processor can enable the entire page to be played via text-to-speech (TTS), enable specific words to be highlighted for playback via TTS, enable highlighting or hover-over to display definitions for words, or highlighting of sections of the results page to allow active reading. In some examples, the processor may present the search results with webpage thumbnails. For example, the webpage thumbnails may be used to identify the webpages in the results without having to read URLs. In some examples, the processor may present the search results with icons representing ranking features. For example, the icons may represent ranking features such as density, readability, among other features that could be used to rank the results. These example features for presenting the ranked results are discussed in greater length with respect to FIG. 6 below.

This process flow diagram is not intended to indicate that the blocks of the method 200 are to be executed in any particular order, or that all of the blocks are to be included in every case. Further, any number of additional blocks not shown may be included within the method 200, depending on the details of the specific implementation.

FIG. 3 is a process flow diagram of an example method for calculating an accessibility score. One or more components of hardware or software of the operating environment 700, may be configured to perform the method 300. For example, the method may be implemented via the processor 704. In some examples, various aspects of the method may be performed in a cloud computing system. The method 300 may begin at block 302.

At block 302, the processor calculates a accessibility score based on a reading level of an extracted text. For example, the reading level can be based on an inclusion list of specific vocabulary words. In some examples, sentence length, sentence grammatical complexity, word length, document length, number of syllables in words, among other suitable factors may be taken into account when determining a reading level. For example, one or more of the additional indices listed in block 306 below may also be used to determine the reading level.

At block 304, the processor modifies the accessibility score based on a complexity score of the extracted text. For example, the complexity score can be calculated based on a mean number of characters per word, a mean number of words per sentence, a number of characters without spaces, a total number of words, a total number of sentences, or a mean number of syllables per word, or any combination thereof.

At block 306, the processor modifies the accessibility score based on an additional index. For example, the additional index can include a Flesch Reading Ease score, a Flesh-Kincaid Grade Level, a Coleman Liau Index, a Gunning-Fog Index, a Simple Measure of Gobbledygook (SMOG), an automated readability index (ARI), a Dale-Chall formula, or a Fry readability formula. For example, the Flesch Reading Ease score may use sentence length (the number of words per sentence) and the number of syllables per word in an equation to calculate the reading level. For example, texts with a very high Flesch Reading Ease score close to 100 are very easy to read, have short sentences and no words of more than two syllables. The Flesh-Kincaid Grade Level may rate text on a U.S. school grade level. For example, a score of 8.0 may mean that an eighth grader can understand the document. Thus, in some examples, a lower Flesh-Kincaid Grade Level may result in a higher accessibility score. The Coleman-Liau Index may rely on characters rather than syllables per word to gauge the understandability of text. For example, the Coleman-Liau index may be calculated using the following formula:

where L is the average number of letters per 100 words and S is the average number of sentences per 100 words. The Gunning Fog Index may be used to estimate the years of formal education needed to understand a text on a first reading. For example, a fog index of 12 requires the reading level of a U.S. high school senior (around 18 years old). A Simple Measure of Gobbledygook (SMOG) grade can be used to estimate the years of education needed to understand a piece of writing. For example, an approximate formula for calculating the SMOG grade is to count the words of three or more syllables in three 10-sentence samples, estimate the count's square root (from the nearest perfect square), and add 3. The automated readability index (ARI) may be used to gauge the understandability of a text and be calculated using the equation:

$$ARI = 4.71 ( \frac{characters}{words} ) + 0.5 ( \frac{words}{sentences} ) - 21.43 \qquad Eq . 4$$

wherein characters is the number of letters and numbers, words is the number of spaces, and sentences is the number of sentences. The sentences may be counted by hand as each text was typed. The Dale-Chall readability formula is a readability test that provides a numeric gauge of the comprehension difficulty that readers come upon when reading a text. The Dale-Chall readability formula uses a list of 3000 words that groups of fourth-grade American students could reliably understand, considering any word not on that list to be difficult. The Fry readability formula may calculate grade level by the average number of sentences (y-axis) and syllables (x-axis) per hundred words. These averages are then plotted onto a specific graph; the intersection of the average number of sentences and the average number of syllables determines the reading level of the content. In some examples, the processor may use any combination of additional indexes to calculate the accessibility score.

At block 308, the processor modifies the accessibility score based on a ratio of images to text in a search result, a layout of the search result, or a color scheme of the search result. For example, a search result with a higher ration of images to text may receive a higher accessibility score. A search result with a simpler layout may receive a higher accessibility score. In some examples, a search result with a more readable color scheme, such as a color scheme providing more contrast, may receive a higher accessibility score. For example, the accessibility score may be based on any of the extracted features described in FIG. 4 below.

This process flow diagram is not intended to indicate that the blocks of the method 300 are to be executed in any particular order, or that all of the blocks are to be included in every case. For example, although the accessibility score is calculated in block 302 and modified in blocks 304 and 306, in some examples, the accessibility score may be calculated using any combination of the above blocks. Further, any number of additional blocks not shown may be included within the method 300, depending on the details of the specific implementation.

FIG. 4 is a process flow diagram of an example method for extracting features from search results. One or more components of hardware or software of the operating environment 700, may be configured to perform the method 400. For example, the method may be implemented via the processor 704. In some examples, various aspects of the method may be performed in a cloud computing system. The method 400 may begin at block 402.

At block 402, the processor extracts page structures from the search results. For example, the structures may include headings, lists, etc. In some examples, relevant metrics for structures may include the presence or absence of lists. For example, the list may use the tags: <ul><ol><li><dl>, wherein <ul> is a tag indicating the start of an unordered list, <ol> is a tag indicating an ordered list, and <li> is a tag indicating a list item. In some examples, structures may include the presence or absence of tables. In some examples, structures may include the presence or absence of headings of different levels. For example, the heading levels may be in the form: <h1><h2>, etc. In some examples, structures may include other relevant hypertext markup language (HTML) tags or other structural elements for outlining or summarization. In some examples, the processor may also determine a ratio of amount of text in words or characters in paragraphs versus the amount of text in headings, lists, and tables. Web pages that contain structures may be easier for people with dyslexia to consume than those with very dense text.

At block 404, the processor extracts multimedia from the search results. For example, metrics for multimedia may include the presence or absence of images, or video. In some examples, the processor may take image size or placement into account to discount irrelevant images such as advertisements or small icons that are part of headers, etc. Thus, multimedia may be limited to images that constitute or supplement the main content of a page. In some examples, the processor may penalize ads or small icons that are part of headers as adding to visual distraction. In some examples, a metric for multimedia may include the number of images and videos on the page. In some examples, the processor may calculate a ratio of media to text as another metric.

At block 406, the processor extracts page integrity features from the search results. For example, the processor may determine that sites are less desirable if the sites distribute content across several pages and require selecting icons or arrows to access additional pages of the articles or lists. In some examples, this may include sites that display content using slide shows, etc. In some examples, the processor can calculate a page integrity score that indicates the presence or absence of common indictors that indicate whether a site seems to be employing such a strategy of breaking up content across multiple pages. For example, the processor may extract links to page 1 . . . N, next/previous links, etc. Therefore, results with confusing content may be ranked lower using the extracted page integrity feature. In some examples, the processor may convert the several pages to display the content on one web page. For example, an icon may be used to enter a reading mode to convert the several pages into one page. In some examples, if a page is detected as difficult to read, the processor may automatically select a page in the easier to read mode or include a link to suggest using that mode, etc.

At block 408, the processor extracts visual clarity features from the search results. For example, visual clarity features may include aspects such as the color scheme, contrast level, and font styles of a page. In some examples, fonts such as Sans Serif fonts, monospaced fonts, and roman fonts may be rated higher. In some examples, a frequent use of italics may be penalized. In some examples, larger default font sizes may be rated higher, while font sizes hard-coded to stay small may be penalized. In some examples, color visibility and contrast may be extracted features. For example, two colors may provide good color visibility if the brightness difference and the color difference between the two colors are greater than a set range. In some examples, color brightness may be determined using the formula:

CB=((Red value×299)+(Green value×587)+(Blue value×114))/1000 Eq. 3

wherein the brightness value CB provides a perceived brightness for a color. The range for color brightness difference may be 125 or any other suitable value or range of values. In some examples, color difference may be determined by the formula:

CD=(maximum(Red value 1,Red value 2)−minimum(Red value 1,Red value 2))+(maximum(Green value 1,Green value 2)−minimum(Green value 1,Green value 2))+(maximum(Blue value 1,Blue value 2)−minimum(Blue value 1,Blue value 2)) Eq. 5

wherein the range for color difference may be 500.

This process flow diagram is not intended to indicate that the blocks of the method 400 are to be executed in any particular order, or that all of the blocks are to be included in every case. For example, any combination of the features of 402-408 may be extracted. Further, any number of additional blocks not shown may be included within the method 400, depending on the details of the specific implementation. For example, additional features may be extracted.

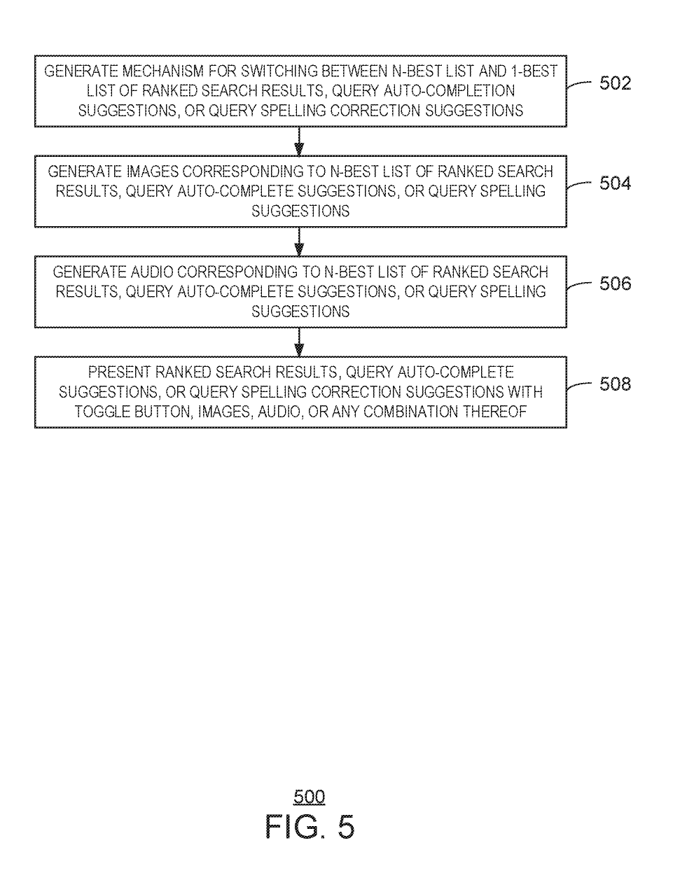

FIG. 5 is a process flow diagram of an example method for modifying a browser to present search results with accessibility features based on an accessibility indicator of a user. One or more components of hardware or software of the operating environment 700, may be configured to perform the method 500. For example, the method may be implemented via the processor 704. In some examples, various aspects of the method may be performed in a cloud computing system. The method 500 may begin at block 502.

At block 502, the processor generates a mechanism for switching between an N-best list and a 1-best list of ranked search results, query auto-completion suggestions, or query spelling correction suggestions. For example, the mechanism may be a toggle button for toggling between an N-best list and a 1-best list of ranked search results, query auto-completion suggestions, or query spelling correction suggestions. In some examples, the mechanism may be a combo box where N can be selected to be any value. An N-best list may be determined by receiving a value for N and returning an N number of higher ranked search results. A 1-best list may be determined by returning a search result that ranked is higher than other ranked search results. For example, for query auto-completion suggestions and/or spelling correction suggestions, the ability to toggle between N-best list and 1-best list may improve the usability of the suggestions.

At block 504, the processor generates images corresponding to an N-best list of ranked search results, query auto-completion suggestions, or query spelling correction suggestions. For example, the processor may generate supplementary images to the websites suggested in N-best lists to help make the meanings of the websites more clear.

At block 506, the processor generates audio corresponding to an N-best list of ranked search results, query auto-completion suggestions, or query spelling correction suggestions. For example, the processor may allow the playing of the pronunciations for each website in the N-best list aloud. Thus, the name of the website may be played aloud. In some examples, snippets from the website may also be played aloud.

At block 508, the processor presents ranked search results, query auto-complete suggestions, or query spelling correction suggestions with the toggle button, the images, the audio, or any combination thereof. For example, the processor may present any combination of the accessibility features, including the ranked search results, query auto-complete suggestions, or query spelling correction suggestions with the toggle button, the images, and the audio based on the accessibility indicator. In some examples, the processor may present a search result page including a toggle button to switch between an N-best and a 1-best list of ranked search results. In some examples, the processor may present a search result page with images corresponding to search results in the N-best list. In some example, the processor may present a search result page with audio corresponding to search results in the N-best list.

This process flow diagram is not intended to indicate that the blocks of the method 500 are to be executed in any particular order, or that all of the blocks are to be included in every case. For example, one or more of the above blocks may be included based on a received accessibility indicator. Further, any number of additional blocks not shown may be included within the method 500, depending on the details of the specific implementation.

FIG. 6 is a process flow diagram of another example method for modifying a browser to present search results with accessibility features based on an accessibility indicator of a user. One or more components of hardware or software of the operating environment 700, may be configured to perform the method 600. For example, the method may be implemented via the processor 704. In some examples, various aspects of the method may be performed in a cloud computing system. The method 600 may begin at block 602.

At block 602, the processor reduces the density of the search results. For example, the processor may remove snippets from the search results. In some examples, the processor may reduce the density of the search results page by removing one or more less useful elements. For example, the processor may remove elements such as news articles, maps, advertisements, among other less useful elements. In some examples, the processor may generate links to more accessible versions of the retrieved search results. For example, a search link in the search results may open a retrieved page in a browser's dedicated reading mode, in a “print view,” or in a mobile version. A “print view” of a website may have less clutter and the mobile version of a website may have narrower columns and thus both may be more accessible.

At block 604, the processor generates interactive content for the search results. For example, the interactive content may include an ability to play an entire page aloud via text to speech. For example, the entire page may be played aloud via a browser button or a toolbar. In some examples, the interactive content may include an ability to highlight a specific word or phrase and play just that part aloud via TTS. For example, a selective TTS feature may enable users to click on individual search snippets and have them read aloud. In some examples, the interactive content may include an ability to highlight or hover over words to see definitions. For example, the definitions may include both a text definition and a visual definition or image. In some examples, the interactive content may include the ability to manually highlight sections of a webpage in different colors to allow for active reading by users.

At block 606, the processor generates webpage thumbnails for the search results. For example, icons may be used to represent web domains. Websites may thus be presented using their icons rather than a list of web addresses.

At block 608, the processor generates icons representing ranking features for the search results and a configuration page for selecting ranking features. For example, an icon may be included to show that reading assistance is available. In some examples, an icon for indicating reading level may be presented as well. For example, the reading level icon may be a bar graph or a thermometer. When a mouse hover is detected, the icon can show reading level and extract from the page the most complicated sentence or words so user can make a judgment as to whether the page is accessible. In some examples, the features can be presented statically via the icons. Alternatively, the ranking features can be interactive. For example, the processor may include a configuration page to allow the user to filter or re-sort the results based on selecting which set of these features are relevant to them. In some examples, reranking can be performed on the search engine result page (SERP) for each search. In some examples, reranking can be performed once on a settings or profile page for the user. For example, the user may customize the search engine to their specific needs and capabilities via the settings or profile page. Thus, for example, users with different forms of dyslexia may customize the rankings to their own specific difficulties.

At block 610, presents the modified search results. For example, the modified search results may have reduced density, interactive content, webpage thumbnails, and icons representing ranking features. In some examples, the modified search results may include one or more of the accessibility features described in blocks 602-610 based on the accessibility indicator. For example, the modified search results may be displayed in a result page without advertisements and having interactive content, such as playable text. In some examples, the modified search results may be displayed with a thumbnail for each search result and icons representing different ranking features. The resulting modified search results with one or more of the accessibility features may thus be easier for some people, such as users with dyslexia, to read and understand.

This process flow diagram is not intended to indicate that the blocks of the method 600 are to be executed in any particular order, or that all of the blocks are to be included in every case. Further, any number of additional blocks not shown may be included within the method 600, depending on the details of the specific implementation. In some examples, the method 600 may also be used to display individual web pages as well.

FIG. 7 is intended to provide a brief, general description of an example operating environment in which the various techniques described herein may be implemented. For example, a method and system for presenting search results can be implemented in such an operating environment. While the claimed subject matter has been described above in the general context of computer-executable instructions of a computer program that runs on a local computer or remote computer, the claimed subject matter also may be implemented in combination with other program modules. Generally, program modules include routines, programs, components, data structures, or the like that perform particular tasks or implement particular abstract data types. The example operating environment 700 includes a computer 702. The computer 702 includes a processing unit 704, a system memory 706, and a system bus 708.

The system bus 708 couples system components including, but not limited to, the system memory 706 to the processing unit 704. The processing unit 704 can be any of various available processors. Dual microprocessors and other multiprocessor architectures also can be employed as the processing unit 704.

The system bus 708 can be any of several types of bus structure, including the memory bus or memory controller, a peripheral bus or external bus, and a local bus using any variety of available bus architectures known to those of ordinary skill in the art. The system memory 706 includes computer-readable storage media that includes volatile memory 710 and nonvolatile memory 712.

The basic input/output system (BIOS), containing the basic routines to transfer information between elements within the computer 702, such as during start-up, is stored in nonvolatile memory 712. By way of illustration, and not limitation, nonvolatile memory 712 can include read-only memory (ROM), programmable ROM (PROM), electrically programmable ROM (EPROM), electrically erasable programmable ROM (EEPROM), or flash memory.

Volatile memory 710 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), SynchLink™ DRAM (SLDRAM), Rambus® direct RAM (RDRAM), direct Rambus® dynamic RAM (DRDRAM), and Rambus® dynamic RAM (RDRAM).

The computer 702 also includes other computer-readable media, such as removable/non-removable, volatile/non-volatile computer storage media. FIG. 7 shows, for example a disk storage 714. Disk storage 714 includes, but is not limited to, devices like a magnetic disk drive, floppy disk drive, tape drive, Jaz drive, Zip drive, LS-210 drive, flash memory card, memory stick, flash drive, and thumb drive.

In addition, disk storage 714 can include storage media separately or in combination with other storage media including, but not limited to, an optical disk drive such as a compact disk, ROM device (CD-ROM), CD recordable drive (CD-R Drive), CD rewritable drive (CD-RW Drive), a digital versatile disk (DVD) drive. To facilitate connection of the disk storage devices 714 to the system bus 708, a removable or non-removable interface is typically used such as interface 716.

It is to be appreciated that FIG. 7 describes software that acts as an intermediary between users and the basic computer resources described in the suitable operating environment 700. Such software includes an operating system 718. The operating system 718, which can be stored on disk storage 714, acts to control and allocate resources of the computer 702.

System applications 720 take advantage of the management of resources by operating system 718 through program modules 722 and program data 724 stored either in system memory 706 or on disk storage 714. It is to be appreciated that the claimed subject matter can be implemented with various operating systems or combinations of operating systems.

A user enters commands or information into the computer 702 through input devices 726. Input devices 726 include, but are not limited to, a pointing device, such as, a mouse, trackball, stylus, and the like, a keyboard, a microphone, a joystick, a satellite dish, a scanner, a TV tuner card, a digital camera, a digital video camera, a web camera, and the like. The input devices 726 connect to the processing unit 704 through the system bus 708 via interface ports 728. Interface ports 728 include, for example, a serial port, a parallel port, a game port, and a universal serial bus (USB).

Output devices 730 use some of the same type of ports as input devices 726. Thus, for example, a USB port may be used to provide input to the computer 702, and to output information from computer 702 to an output device 730.

Output adapter 732 is provided to illustrate that there are some output devices 730 like monitors, speakers, and printers, among other output devices 730, which are accessible via adapters. The output adapters 732 include, by way of illustration and not limitation, video and sound cards that provide a means of connection between the output device 730 and the system bus 708. It can be noted that other devices and systems of devices can provide both input and output capabilities such as remote computers 734.

The computer 702 can be a server hosting various software applications in a networked environment using logical connections to one or more remote computers, such as remote computers 734. The remote computers 734 may be client systems configured with web browsers, PC applications, mobile phone applications, and the like.

The remote computers 734 can be a personal computer, a server, a router, a network PC, a workstation, a microprocessor based appliance, a mobile phone, a peer device or other common network node and the like, and typically includes many or all of the elements described relative to the computer 702. Remote computers 734 can be logically connected to the computer 702 through a network interface 736 and then connected via a communication connection 738, which may be wireless.

Network interface 736 encompasses wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection 738 refers to the hardware/software employed to connect the network interface 736 to the bus 708. While communication connection 738 is shown for illustrative clarity inside computer 702, it can also be external to the computer 702. The hardware/software for connection to the network interface 736 may include, for exemplary purposes, internal and external technologies such as, mobile phone switches, modems including regular telephone grade modems, cable modems and DSL modems, ISDN adapters, and Ethernet cards.

An example processing unit 704 for the server may be a computing cluster. The disk storage 714 may include an enterprise data storage system, for example, holding thousands of impressions.

The user may store the code samples to disk storage 714. The disk storage 714 can include a number of modules 722 configured to implement ranking and presentation of search results, including a receiver module 740, an extractor module 742, a scorer module 744, a ranker module 746, and a presenter module 748. The receiver module 740, extractor module 742, scorer module 744, ranker module 746, and presenter module 748 refer to structural elements that perform associated functions. In some embodiments, the functionalities of the receiver module 740, extractor module 742, scorer module 744, ranker module 746, and the presenter module 748 can be implemented with logic, wherein the logic, as referred to herein, can include any suitable hardware (e.g., a processor, among others), software (e.g., an application, among others), firmware, or any combination of hardware, software, and firmware. For example, the receiver module 740 can be configured to receive an accessibility indicator of a user. The receive module 740 can also be configured to receive a set of search results in response to a query. In some examples, the receiver module 740 may have received the query via voice input, transcribe the query to text, and forward the query to a search engine to receive the set of search results. In some examples, a query may be specified via voice input regardless of the browser type or device type used.

Further, the disk storage 714 can include an extractor module 742 configured to extract one or more features and text from each of the search results. For example, the feature may be a page structure, a multimedia, a page integrity feature, or a visual clarity feature. In some examples, the scorer module 744 may include code to calculate an accessibility score for each of the search results based on the extracted features and the text. For example, the accessibility score may be based at least on a reading level of the extracted text. In some examples, the reading level can be based on an inclusion list of specific vocabulary words. In some examples, the accessibility score may also be based on the ratio of images to text, or a layout, or a color scheme of the page, with or without the reading level information. In some examples, the accessibility score can be based on a complexity score of the text. For example, the complexity score can be calculated based on a mean number of characters per word, a mean number of words per sentence, a number of characters without spaces, a total number of words, a total number of sentences, or a mean number of syllables per word, or any combination thereof. In some examples, the accessibility score can be based on an additional index. For example, the additional index may be a Flesch Reading Ease score, a Flesh-Kincaid Grade Level, a Coleman Liau Index, a Gunning-Fog Index, a SMOG, an automated readability index, a Dale-Chall formula, or a Fry readability formula, or any combination thereof. In some examples, the readability score can be based on a ratio of images to text in each search result, a layout of each search result, or a color scheme of each search result. The disk storage 714 can include a ranker module 746 configured to rank the set of search results based on the accessibility score. The disk storage 714 can also include a presenter module 748 configured to modify a web browser to present the ranked search results in place of the set of search results in response to receiving the accessibility indicator of a user. In some examples, the presenter module 748 can present a toggle button for toggling between an N-best list and a 1-best list of the ranked search results in a query auto-completion suggestion or a spelling correction suggestion based on the accessibility indicator. In some examples, the presenter module 748 can add images corresponding to search results in an n-best list of the ranked search results or play an audio clip corresponding to the search results in the n-best list based on the accessibility indicator. In some examples, the presenter module 748 can present search results with reduced density, interactive content, webpage thumbnails, icons representing ranking features, or any combination thereof, based on the accessibility indicator as discussed in greater length with respect to FIG. 6 above.

In some examples, some or all of the processes performed for ranking search results or presenting search results can be performed in a cloud service and reloaded on the client computer of the user. For example, some or all of the applications described above for ranking search results or presenting search results could be running in a cloud service and receiving input from a user through a client computer.

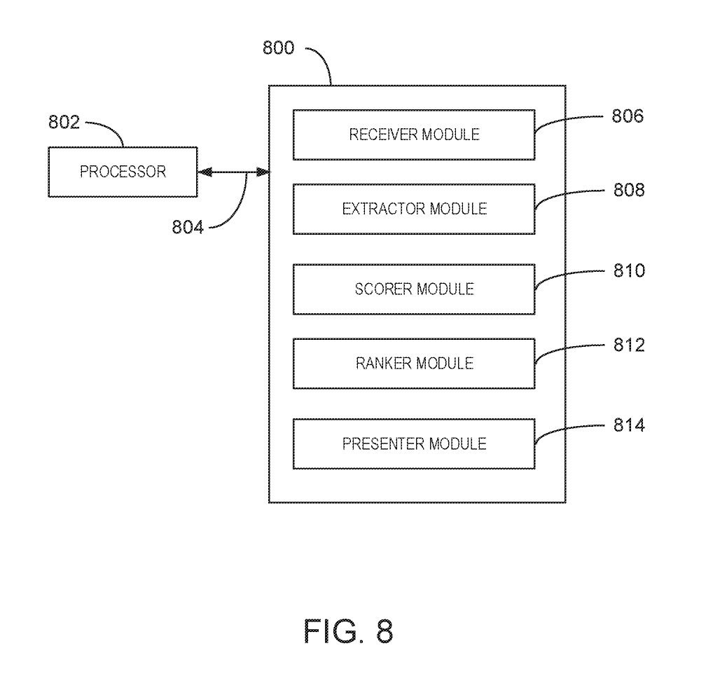

FIG. 8 is a block diagram showing computer-readable storage media 800 that can store instructions for presenting search results. The computer-readable storage media 800 may be accessed by a processor 802 over a computer bus 804. Furthermore, the computer-readable storage media 800 may include code to direct the processor 802 to perform steps of the techniques disclosed herein.

The computer-readable storage media 800 can include code such as a receiver module 806 configured to receive an accessibility indicator of a user. For example, the accessibility indicator may indicate one or more user preferences and accessibility features to include. The receiver module 806 can also be configured to receive a set of search results in response to a query. In some examples, the receiver module 806 can be configured to receive the query in the form of audio input. For example, the receiver module 806 may transcribe the audio input into text. An extractor module 808 can be configured to extract at least one feature and text from each of the search results. For example, the feature may include a page structure, a multimedia, a page integrity feature, or a visual clarity feature. Further, the computer-readable storage media 800 can include a scorer module 810 configured to calculate an accessibility score for each of the search results based on the at least one extracted feature and the text. For example, the scorer module 810 may be configured to calculate the accessibility score based at least on a reading level of the extracted text. In some examples, the reading level can be based on an inclusion list of specific vocabulary words. In some examples, the accessibility score can be based on a complexity score of the text, wherein the complexity score is calculated based on a mean number of characters per word, a mean number of words per sentence, a number of characters without spaces, a total number of words, a total number of sentences, or a mean number of syllables per word, or any combination thereof. In some examples, the accessibility score can also be based on an additional index, wherein the additional index includes a Flesch Reading Ease score, a Flesh-Kincaid Grade Level, a Coleman Liau Index, a Gunning-Fog Index, a SMOG, an automated readability index, a Dale-Chall formula, a Fry readability formula, or any combination thereof. In some examples, the accessibility score can be based on a ratio of images to text in each search result, a layout of each search result, or a color scheme of each search result.

The computer-readable storage media 800 can also include a ranker module 812 configured to rank the set of search results based on the accessibility score. For example, the ranker module 812 can compute an accessibility score for each search result and sort the search results by accessibility score. A presenter module 814 can then modify a web browser to present the ranked search results in place of the set of search results in response to receiving the accessibility indicator. In some examples, the presenter module 814 can include instructions to present a toggle button for toggling between an N-best list and a 1-best list for ranked search results, query auto-completion suggestions, or query spelling correction suggestions based on the accessibility indicator. In some examples, the presenter module 814 can include instructions to present images corresponding to elements in an N-best list of ranked search results, query auto-completion suggestions, or query spelling correction suggestions based on the accessibility indicator. In some examples, the presenter module 814 can include instructions to present audio corresponding to elements in an N-best list of ranked search results, query auto-completion suggestions, or query spelling correction suggestions based on the accessibility indicator.

It is to be understood that any number of additional software components not shown in FIG. 8 may be included within the computer-readable storage media 800, depending on the specific application. Although the subject matter has been described in language specific to structural features and/or methods, it is to be understood that the subject matter defined in the appended claims is not necessarily limited to the specific structural features or methods described above. Rather, the specific structural features and methods described above are disclosed as example forms of implementing the claims.

### Example 1

This example provides for an example system for presenting search results. The example system includes a computer processor and a computer-readable memory storage device storing executable instructions that can be executed by the processor to cause the processor to receive an accessibility indicator of a user. The executable instructions can be executed by the processor to receive a set of search results in response to a query. The executable instructions can be executed by the processor to extract a feature and text from each of the search results. The executable instructions can be executed by the processor to calculate an accessibility score for each of the search results based on the extracted feature and the text. The executable instructions can be executed by the processor to rank the set of search results based on the accessibility score. The executable instructions can be executed by the processor to modify a web browser to present the ranked search results in place of the set of search results in response to receiving the accessibility indicator. Alternatively, or in addition, the feature includes a page structure, a multimedia metric, a page integrity feature, or a visual clarity feature. Alternatively, or in addition, the executable instructions can be executed by the processor to present a toggle button for toggling between an N-best list and a 1-best list of ranked search results, query auto-completion suggestions, or query spelling correction suggestions based on the accessibility indicator. Alternatively, or in addition, the executable instructions can be executed by the processor to present ranked search result, a query auto-completion suggestion, or a query spelling correction suggestion with an image or audio based on the accessibility indicator. Alternatively, or in addition, the accessibility score is based at least on a reading level of the extracted text, wherein the reading level is based on a list of specific vocabulary words. Alternatively, or in addition, the accessibility score is based on a complexity score of the extracted text, wherein the complexity score is calculated based on a mean number of characters per word, a mean number of words per sentence, a number of characters without spaces, a total number of words, a total number of sentences, a mean number of syllables per word, or any combination thereof. Alternatively, or in addition, the accessibility score is based on an additional index, wherein the additional index includes a Flesch Reading Ease score, a Flesh-Kincaid Grade Level, a Coleman Liau Index, a Gunning-Fog Index, a SMOG, an automated readability index, a Dale-Chall formula, a Fry readability formula, or any combination thereof. Alternatively, or in addition, the accessibility is based on a ratio of images to text in each search result, a layout of each search result, or a color scheme of each search result.

### Example 2

This example provides for an method for presenting search results. The example method includes receiving an accessibility indicator of a user. The method also includes receiving a set of search results in response to a query. The method further also includes extracting a feature and text from each of the search results. The method further also includes calculating an accessibility score for each of the search results based on the extracted feature and the text. The method further also includes ranking the set of search results based on the accessibility score. The method further also includes presenting the ranked search results in response to receiving the accessibility indicator. Alternatively, or in addition, the method can also include calculating the accessibility score based on a reading level of the extracted text and a complexity score of the extracted text. Alternatively, or in addition, the feature includes a page structure, a multimedia, a page integrity feature, or a visual clarity feature. Alternatively, or in addition, modifying the web browser further includes presenting the search results with a reduced density based on the accessibility indicator. Alternatively, or in addition, modifying the web browser further includes presenting the search results with interactive content based on the accessibility indicator. Alternatively, or in addition, modifying the web browser further includes presenting the search results with webpage thumbnails based on the accessibility indicator. Alternatively, or in addition, modifying the web browser further includes presenting the search results with icons representing ranking features or including a configuration page for selecting ranking features based on the accessibility indicator.

### Example 3

This example provides for an example computer-readable storage device for presenting search results. The example computer-readable storage device includes executable instructions that can be executed by a processor to cause the processor to receive an accessibility indicator of a user. The executable instructions can be executed by the processor to receive a set of search results in response to a query. The executable instructions can be executed by the processor to extract at least one feature and text from each of the search results. The executable instructions can be executed by the processor to calculate an accessibility score for each of the search results based on the at least one extracted feature and the text. The executable instructions can be executed by the processor to rank the set of search results based on the accessibility score. The executable instructions can be executed by the processor to modify a web browser to present the ranked search results in place of the set of search results in response to receiving the accessibility indicator. Alternatively, or in addition, the feature includes a page structure, a multimedia, a page integrity feature, or a visual clarity feature. Alternatively, or in addition, the executable instructions can be executed by the processor to present a mechanism for switching between an N-best list and a 1-best list for query auto-completion suggestions or query spelling correction suggestions based on the accessibility indicator. Alternatively, or in addition, the executable instructions can be executed by the processor to present images corresponding to an element in an N-best list of ranked search results, query auto-completion suggestions, or query spelling correction suggestions based on the accessibility indicator. Alternatively, or in addition, the executable instructions can be executed by the processor to present audio corresponding to an element in an N-best list of ranked search results, query auto-completion suggestions, or query spelling correction suggestions based on the accessibility indicator.

### Example 4

This example provides for an example system for presenting search results. The example system includes means for receiving an accessibility indicator of a user. The system may also include means for receiving a set of search results in response to a query. The system may also include means for extracting a feature and text from each of the search results. The system may also include means for calculating an accessibility score for each of the search results based on the extracted feature and the text. The system may also include means for ranking the set of search results based on the accessibility score. The system may also include means for modifying a web browser to present the ranked search results in place of the set of search results in response to receiving the accessibility indicator. Alternatively, or in addition, the feature includes a page structure, a multimedia metric, a page integrity feature, or a visual clarity feature. Alternatively, or in addition, the executable instructions can be executed by the processor to present a toggle button for toggling between an N-best list and a 1-best list of ranked search results, query auto-completion suggestions, or query spelling correction suggestions based on the accessibility indicator. Alternatively, or in addition, the executable instructions can be executed by the processor to present ranked search result, a query auto-completion suggestion, or a query spelling correction suggestion with an image or audio based on the accessibility indicator. Alternatively, or in addition, the accessibility score is based at least on a reading level of the extracted text, wherein the reading level is based on a list of specific vocabulary words. Alternatively, or in addition, the accessibility score is based on a complexity score of the extracted text, wherein the complexity score is calculated based on a mean number of characters per word, a mean number of words per sentence, a number of characters without spaces, a total number of words, a total number of sentences, a mean number of syllables per word, or any combination thereof. Alternatively, or in addition, the accessibility score is based on an additional index, wherein the additional index includes a Flesch Reading Ease score, a Flesh-Kincaid Grade Level, a Coleman Liau Index, a Gunning-Fog Index, a SMOG, an automated readability index, a Dale-Chall formula, a Fry readability formula, or any combination thereof. Alternatively, or in addition, the accessibility is based on a ratio of images to text in each search result, a layout of each search result, or a color scheme of each search result.

What has been described above includes examples of the disclosed subject matter. It is, of course, not possible to describe every conceivable combination of components or methodologies for purposes of describing the disclosed subject matter, but one of ordinary skill in the art may recognize that many further combinations and permutations of the disclosed subject matter are possible. Accordingly, the disclosed subject matter is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component, e.g., a functional equivalent, even though not structurally equivalent to the disclosed structure, which performs the function in the herein illustrated exemplary aspects of the disclosed subject matter. In this regard, it will also be recognized that the innovation includes a system as well as a computer-readable storage media having computer-executable instructions for performing the acts and events of the various methods of the disclosed subject matter.

There are multiple ways of implementing the disclosed subject matter, e.g., an appropriate API, tool kit, driver code, operating system, control, standalone or downloadable software object, etc., which enables applications and services to use the techniques described herein. The disclosed subject matter contemplates the use from the standpoint of an API (or other software object), as well as from a software or hardware object that operates according to the techniques set forth herein. Thus, various implementations of the disclosed subject matter described herein may have aspects that are wholly in hardware, partly in hardware and partly in software, as well as in software.

The aforementioned systems have been described with respect to interaction between several components. It can be appreciated that such systems and components can include those components or specified sub-components, some of the specified components or sub-components, and additional components, and according to various permutations and combinations of the foregoing. Sub-components can also be implemented as components communicatively coupled to other components rather than included within parent components (hierarchical).

Additionally, it can be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

In addition, while a particular feature of the disclosed subject matter may have been disclosed with respect to one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

What is claimed is:

1. A system for presenting search results, comprising:
a computer memory; and
a computer processor to:
receive a set of search results in response to a query;
extract a feature and text from each of the search results;
calculate an accessibility score for each of the search results based on the extracted feature and the text;
rank the set of search results based on an accessibility score; and
present the ranked search results in response to receiving an accessibility indicator of a user.

2. The system of claim 1, wherein the feature comprises a page structure, a multimedia metric, a page integrity feature, or a visual clarity feature.

3. The system of claim 1, wherein the processor is to present a toggle button for toggling between an N-best list and a 1-best list of ranked search results, query auto-completion suggestions, or query spelling correction suggestions based on the accessibility indicator of the user.

4. The system of claim 1, wherein the processor is to present ranked search result, a query auto-completion suggestion, or a query spelling correction suggestion with an image or audio based on the accessibility indicator of the user.

5. The system of claim 1, wherein the accessibility score is based at least on a reading level of the extracted text, wherein the reading level is based on a list of specific vocabulary words.

6. The system of claim 1, wherein the accessibility score is based on a complexity score of the extracted text, wherein the complexity score is calculated based on a mean number of characters per word, a mean number of words per sentence, a number of characters without spaces, a total number of words, a total number of sentences, a mean number of syllables per word, or any combination thereof.

7. The system of claim 1, wherein the accessibility score is based on an additional index, wherein the additional index comprises a Flesch Reading Ease score, a Flesh-Kincaid Grade Level, a Coleman Liau Index, a Gunning-Fog Index, a SMOG, an automated readability index, a Dale-Chall formula, a Fry readability formula, or any combination thereof.

8. The system of claim 1, wherein the accessibility is based on a ratio of images to text in each search result, a layout of each search result, or a color scheme of each search result.

9. A method for presenting search results, comprising:
receiving a set of search results in response to a query;
extracting a feature and text from each of the search results;
calculating an accessibility score for each of the search results based on the extracted feature and the text;
ranking the set of search results based on the accessibility score; and
presenting the ranked search results in response to receiving an accessibility indicator of a user.

10. The method of claim 9, further comprising calculating the accessibility score based on a reading level of the extracted text and a complexity score of the extracted text.

11. The method of claim 9, wherein the feature comprises a page structure, a multimedia, a page integrity feature, or a visual clarity feature.

12. The method of claim 9, wherein modifying the web browser further comprises presenting the search results with a reduced density based on the accessibility indicator of the user.

13. The method of claim 9, wherein modifying the web browser further comprises presenting the search results with interactive content based on the accessibility indicator of the user.

14. The method of claim 9, wherein modifying the web browser further comprises presenting the search results with webpage thumbnails based on the accessibility indicator of the user.

15. The method of claim 9, wherein modifying the web browser further comprises presenting the search results with icons representing ranking features or including a configuration page for selecting ranking features based on the accessibility indicator of a user.

16. A computer-readable storage device for presenting search results, comprising instructions that cause a computer processor to:
receive a set of search results in response to a query;
extract at least one feature and text from each of the search results;
calculate an accessibility score for each of the search results based on the at least one extracted feature and the text;
rank the set of search results based on the accessibility score; and
present the ranked search results in response to receiving an accessibility indicator of the user.

17. The computer-readable storage device of claim 16, wherein the feature comprises a page structure, a multimedia, a page integrity feature, or a visual clarity feature.

18. The computer-readable storage device of claim 16, comprising instructions that cause the computer processor to present a mechanism for switching between an N-best list and a 1-best list for query auto-completion suggestions or query spelling correction suggestions based on the accessibility indicator of the user.

19. The computer-readable storage device of claim 16, comprising instructions that cause the computer processor to present images corresponding to an element in an N-best list of ranked search results, query auto-completion suggestions, or query spelling correction suggestions based on the accessibility indicator of the user.

20. The computer-readable storage device of claim 16, comprising instructions that cause the computer processor to present audio corresponding to an element in an N-best list of ranked search results, query auto-completion suggestions, or query spelling correction suggestions based on the accessibility indicator of the user.
